(19) United States
(12) Patent Application Publication
(10) Pub. No.: US 2026/0363229 A1
(43) Pub. Date: Nov. 19, 2026

(54) TRAP LOCK

(71) Applicant: Dennis M. Johnson, Kalispell, MT (US)

(72) Inventor: Dennis M. Johnson, Kalispell, MT (US)

(21) Appl. No.: 19/673,828

(22) Filed: May 11, 2026

Related U.S. Application Data
(60) Provisional application No. 63/806,003, filed on May 15, 2025.

(51) Int. Cl. A01M 23/28

(52) U.S. Cl. CPC A01M 23/28

(57) ABSTRACT

Described here is a Trap Lock, which can be installed into a spring-loaded foot-hold trap and will prevent the trap from inadvertently firing. As such, a user can load their traps in the safe conditions of their home or garage and install the Trap Lock. Once installed, the Trap Lock prevents the trap from firing during transport to the field. The Trap Lock handle provides for a convenient and safe way for a user to handle and carry traps without risk of injury. Once in the field, the Trap Lock can be uninstalled, and the trap will be preset and ready to use.

### CROSS REFERENCE TO RELATED APPLICATIONS

This is a U.S. Nonprovisional Application, which claims priority from U.S. Provisional Application no. 63/806,003 filed May 15, 2025, the disclosure of which is hereby incorporated by reference in its entirety to provide continuity of disclosure.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

The invention described herein relates to the field of animal trapping. The herein described invention is a novel trap lock, which allows a user to safely pre-set a trap before entering the field. Once installed, the Trap Lock locks a set trap to prevent unwanted triggering of the trap for safe transport and handling prior to heading out into the field for trap use.

In the field of animal trapping, trappers must haul gear including traps, chains, anchors, drags, bait, shovel, and mallet into the field to prepare a trap line. Traps are generally hauled into the field in their “sprung,” “triggered,” or “fired” position to avoid an accidental triggering of a trap while in transport. Once in the field, the trapper must then set the trap to be used. There are many different traps utilized in the field of trapping. One common type of trap is a spring-loaded, foot-hold trap. Such traps are used to catch animals of all sizes. Trap size generally varies according to species of the animal being sought. Naturally, larger animals, such as wolves, require a large trap. Large foot-hold traps utilize large coil springs, which produce a tremendous amount of force. Such force is necessary to hold a large animal such as wolf.

The act of setting a large spring-loaded foot-hold trap can be dangerous. To set such a trap, a trapper generally must stand on opposing trap lever arms, which relieve tension of the trap's coil springs from the trap jaws. Once tension is relieved from the trap jaws, the trapper can then open the trap jaws and engage a trap pan tab into a loaded jaw notch, which holds the trap jaws in the set position. Once the trap is set, weight placed on the trap pan will release the trap pan tab from the loaded jaw notch and fire the trap. Safely setting a trap requires a user to first, be of a sufficient body weight to overcome the coil spring tension of the trap while stepping on the opposing trap lever arms. Large traps can require 200 lbs. of force to properly depress the trap lever arms to relieve the coil spring tension of such traps. Second, the user must have sufficient balance to be able to reliably stand on the opposing lever arms. If a user loses their balance while attempting to depress the lever arms, the trap jaws can close unexpectedly while the user is in an awkward position, which can lead to injury. And third, setting a spring-loaded trap in this manner requires the trap to be on a level unobstructed surface during the setting procedure.

As such, there are both human physical limitations and environmental limitations, which can lead to improper and unsafe trap use. For example, failing to properly place the pan tab and notch mechanism can result in unwanted trap firing. Inadvertently touching the pan can cause unwanted firing of the trap. Dropping or jostling a set trap can also cause unwanted trap firing. Any of these situations can be caused by the human and environmental limitations common with trapping. Any unwanted or premature trap firing can cause serious injury to a user.

Furthermore, in North America, the majority of trapping seasons occur during the winter months. Trapping generally occurs in remote locations with rugged terrain. It is common to encounter deep snow, rocky terrain, and unlevel ground conditions in the field. Such adverse environmental conditions can make trap setting difficult, if not impossible and/or dangerous in the field. As such, a need exists for the Trap Lock described herein.

### BRIEF SUMMARY OF THE INVENTION

Due to the problems identified above, a need exists for the Trap Lock described herein. The Trap Lock is comprised of a main body with an upper and lower surface. One end of the main body is comprised of a handle. Fixed to the upper surface of the main body is a sliding pan wedge, which engages and prevents a trap pan from being depressed, and two symmetrical loose jaw supports, which prevent movement of the loose jaw nor movement of the pan tab from the loaded jaw notch. Said handle defines an interior space, wherein a sear trigger is affixed so that a loose jaw latch protrudes upward from the plane created by the main body to firmly hold a loose jaw of a trap and lock the device in place. The Trap Lock can be constructed of any material capable of withstanding high force and impact forces. The preferred materials used to construct the Trap Lock are aluminum, high strength plastics, and fiber reinforced polymers.

The Trap Lock can be installed into a spring-loaded foot-hold trap and will prevent the trap from inadvertently firing. As such, a user can load their traps in the safe conditions of their home or garage and install the Trap Lock. Once installed, the Trap Lock prevents the trap from firing during transport to the field. The Trap Lock handle provides a convenient and safe way for a user to handle and carry traps without risk of injury. Once in the field, the Trap Lock can be uninstalled, and the trap will be preset and ready to use.

The Trap Lock described herein solves the problems identified above associated with human and environmental limitations encountered by transporting and setting traps in the field. First, a user can safely pre-load their traps in the controlled conditions of their own home or garage. For example, a user who is not of sufficient weight to depress the opposing trap lever arms to relieve jaw tension can utilize specialized leveraging tools to load the trap or have someone else load the trap for them. Once the trap is loaded, the user can install the Trap Lock and safely transport the preloaded trap to the field. Second, a user can preload all traps in controlled conditions, with balance aids if necessary to minimize any risk of losing balance during the trap loading procedure. Lastly, the Trap Lock allows the user to preload their traps in a controlled environment and safely transport their traps to the field. For example, a user will be able to preload their traps and not have to contend with deep snow or ice, which makes trap loading extremely difficult if not impossible. As such, the Trap Lock described herein is a useful and novel invention for the industry.

### BRIEF DESCRIPTION OF THE DRAWINGS

FIG. 1 is a perspective view of the upper surface of the Trap Lock.

FIG. 2 is a perspective view of the Trap Lock installed in a loaded trap.

FIG. 3 is a longitudinal horizontal plane view from main body first end to handle end showing sliding pan wedge, two symmetrical loose jaw supports and sear trigger.

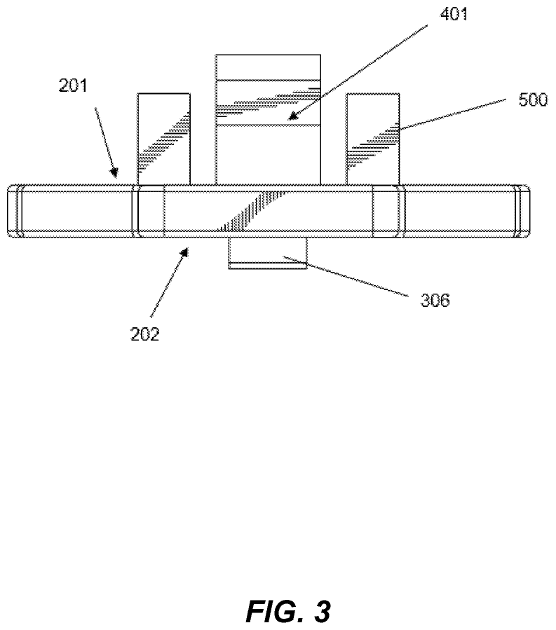

FIG. 4 is a horizontal side view showing sliding pan wedge, loose jaw support, sear catch, and sear trigger.

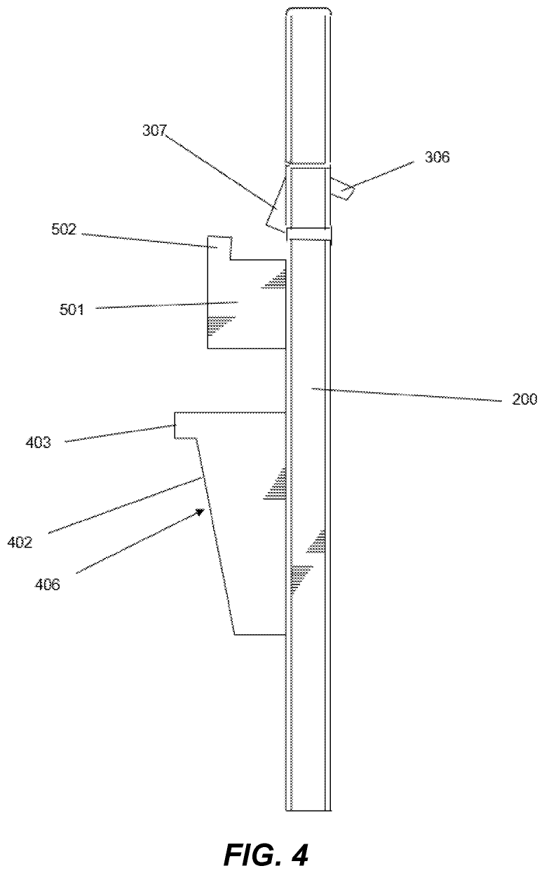

FIG. 5 is an exploded perspective view of Trap Lock showing all parts of the device in detail.

FIG. 6 is a series of horizontal side views showing Trap Lock installation into a loaded trap. A. Beginning insertion of Trap Lock. B. Engaging sliding pan wedge with underside of trap pan. C. Depressing sear trigger to allow loose jaw of trap to engage surface of upper main body. D. Engaging of loose jaw of trap with loose jaw support and releasing sear trigger to engage loose jaw latch with loose jaw.

FIG. 7 is a series of horizontal side views showing Trap Safety Lock deinstallation from a loaded trap. A. Depressing sear trigger to disengage loose jaw latch from loose trap jaw. B. Disengaging loose trap jaw from loose jaw support. C. Disengaging loose trap jaw from surface of upper main body. D. Disengaging sliding pan wedge from underside of trap pan.

### DETAILED DESCRIPTION OF THE INVENTION

Although only some embodiments of the invention are explained in detail, the figures and explanations should be understood as illustrations only and are not intended to limit the invention in its scope. Also, in describing the embodiments, specific terminology may be used, but it should be understood that specific terms include all technical equivalents that operate in similar manners to accomplish similar purposes.

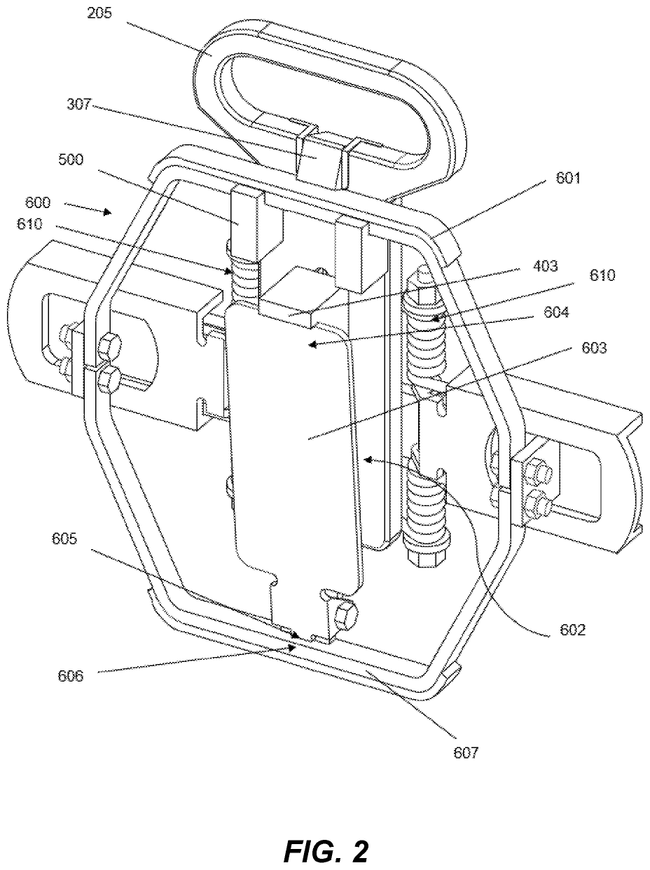

With reference to the drawings, the preferred embodiment of the subject Trap Lock 100 is described in detail below. The Trap Lock 100 is comprised of a main body 200, comprising an upper surface 201, a bottom surface 202, a first insertion end 203 and a second handle end 204. Said main body 200 is roughly the width of a distance between two sets of coil springs 610 of a spring-loaded trap as shown in FIG. 2. Said second handle end 204 is further comprised of a handle 205, which is continuous with said main body 200. Said handle 205 is comprised of an exterior border 206 and an interior border 207, which define said handle 205.

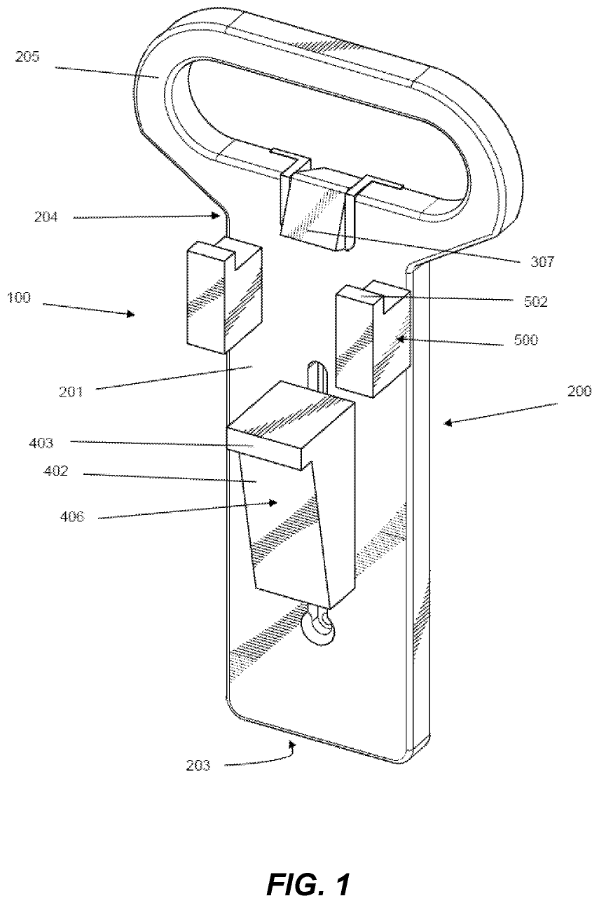

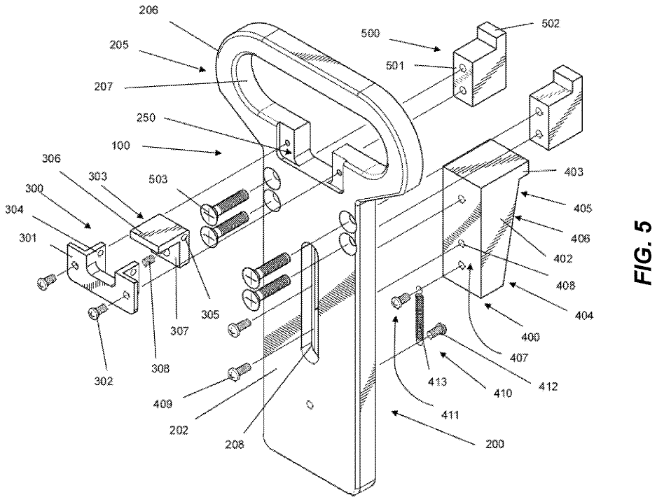

Referring now to FIG. 1 and FIG. 5, The Trap Lock 100 is further comprised of a sear trigger assembly 300, which is affixed to a central junction 250 of said handle 205 and said main body 200. Said sear trigger assembly is comprised of a sear body 301, which is fixed to a recess of the bottom surface 202 of said main body 200 at the central junction 250. One familiar with the art would appreciate that said sear body 301 could be fixed to said main body with any known connection means. In the preferred embodiment said sear body is fixed to said main body with pan head bolts 302. A sear trigger-latch 303 is a 90-degree solid construct, which is connected to said sear body 301 at two opposing sear body brackets 304. Said sear trigger-latch 303 is connected with pins to allow rotation of said sear trigger-latch 303 at a 90-degree junction 305 of said sear trigger-latch 303. Said sear trigger-latch 303 is connected to a trigger 306 of said sear trigger-latch 303 extends downward from said bottom surface 202 of said main body 200 and a loose jaw latch 307 extends upward from said upper surface 201 of said main body 200. Said sear trigger assembly 300 is further comprised of a sear spring 308 between said sear body 301 and said sear trigger-latch 303. Said sear spring 308 provides tension to hold said loose jaw latch 307 in an engaged position with a loose jaw 601 of a spring-loaded trap 600. Depressing said trigger 306 disengages said loose jaw latch 307 from said loose jaw 601 due to rotation of the sear trigger-latch 303 at said 90-degree junction 305 of said sear trigger-latch 303.

Still referring to FIG. 1 and FIG. 5, said Trap Lock 100 is further comprised of a sliding pan wedge assembly 400. Said sliding pan wedge assembly 400 is comprised of a pan wedge 401, which is comprised of a wedge 402 portion and pan stop 403 portion. Said wedge 402 portion is substantially wedge shaped with a first thin end 404 and a second thick end 405. The purpose of said wedge 402 portion is to slide underneath and engage a bottom side 602 of a spring-loaded trap 600 pan 603 with an upper surface 406 of said wedge 402 portion. Said wedge 402 portion is further comprised of a flat bottom surface 407, which engages and slides upon the upper surface 201 of said main body 200. The bottom surface 407 of said wedge 402 is further comprised of a plurality of holes 408, which receive a plurality of screws 409 for connecting said wedge 402 to said main body 200. Said main body comprises a central channel 208, wherein said plurality of screws traverse to create a sliding connection between said wedge 402 and said main body 200. Said sliding pan wedge assembly 400 is further comprised of a wedge spring assembly 410, wherein a first set screw 411 is affixed near the first thin end 404 bottom surface 407 of said wedge 402 and traverses said central channel 208. A second set screw 412 is affixed in proximity to the first insertion end 203 of the upper surface 201 of said main body 200. A wedge slide spring 413 is connected between said first set screw 411 and second set screw 412, which allows said wedge 402 to slide toward said handle end 204 when said Trap Safety Lock 100 is inserted into a loaded trap 600. This sliding motion allows said wedge 402 to firmly engage the bottom side 602 of said pan 603 to prevent said pan from being depressed and prematurely firing the trap 600. Spring tension of said wedge slide spring 413 also provides firm tension of said pan stop 403 against a first end 604 of said pan 603. When installed, said sliding pan wedge assembly 400 firmly locks the pan 603 in place to prevent any movement of said pan 603 or disengagement of a pan tab 605 from a loaded jaw notch 606 of a loaded jaw 607 while the trap 600 is in the loaded configuration.

Said Trap Lock 100 is further comprised of a or a plurality of loose jaw supports 500. Said loose jaw supports 500 are comprised of a lower main block 501 and an upper loose jaw tab 502. Said loose jaw tabs 502 extend from said lower main block toward said second handle end 204. Said loose jaw supports are affixed to the upper surface 201 of said main body 200 in the proximity to said handle end 204 by a plurality of loose jaw support screws 503. When the Trap Lock 100 is installed in a loaded trap 600, said loose jaw supports 500 act to retain said loose jaw 601 in the fully open position. To accomplish this retention of the loose jaw 601, said loose jaw supports 500 work in conjunction with said sliding pan wedge assembly 400. As noted above, said spring tension of said wedge slide spring 413 provides firm tension of said pan stop 403 against a first end 604 of said pan 603. Said wedge slide spring 413 also provides a counter force toward said handle end 204, which firmly pushes said loose jaw supports 500 into said loose jaw 601 wherein said loose jaw tabs 502 provide an upper stop to firmly grasp and prevent any movement of said loose jaw 601.

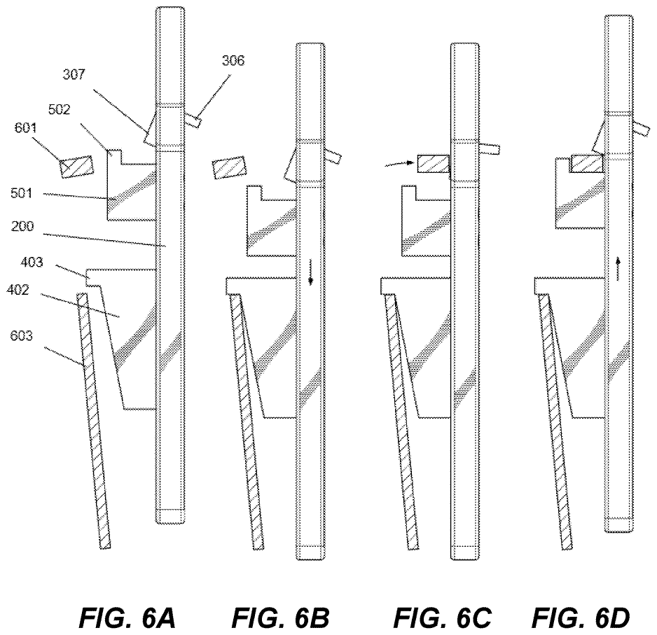

Now referring to FIG. 2 and FIG. 6 to install the Trap Lock 100 into a loaded trap 600 a user will grasp said handle 205 and insert said first insertion end 203 underneath said loose jaw 601 and under said pan 603 (FIG. 6A) to engage said wedge 402 with said pan 603 bottom side 602. FIG. 6B. The user then depresses said trigger 306 of said sear trigger-latch 303 to move said loose jaw latch 307 flush with the upper surface 201 of said main body 200. FIG. 6C. This allows said loose jaw 601 to firmly engage with the lower main blocks 501 and upper loose jaw tabs 502 of said loose jaw supports 500. Spring tension of said wedge slide spring 413 provides firm tension of said pan stop 403 against a first end 604 of said pan 603. Said wedge slide spring 413 also provides a counter force toward said handle end 204, which firmly pushes said loose jaw supports 500 into said loose jaw 601 wherein said loose jaw tabs 502 provide an upper stop to firmly grasp said loose jaw 601. The user then releases said trigger 306, which allows said loose jaw latch 307 to firmly engage with said loose jaw 601, which limits any longitudinal movement of said trap 600. FIG. 6D. Once installed, said wedge 402 firmly engages the bottom side 602 of said pan 603 to prevent said pan from being depressed and prematurely firing said trap 600. A user may then safely carry and handle the trap 600 without risk of the trap firing prematurely.

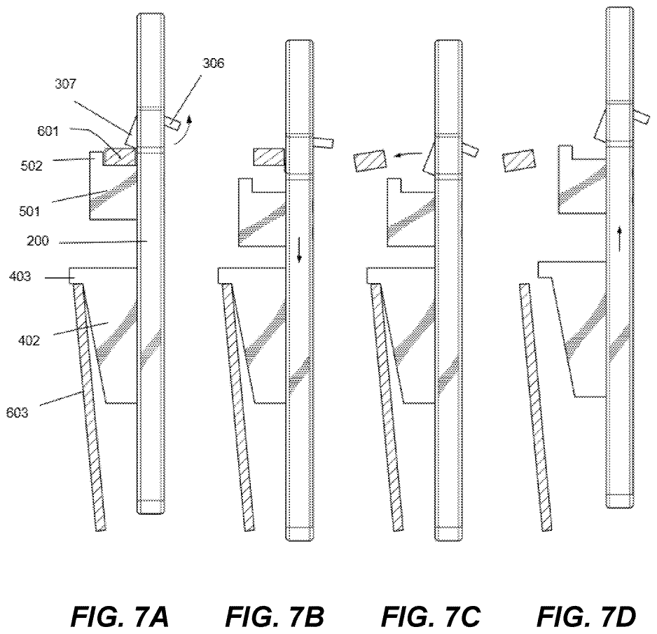

Now referring to FIG. 2 and FIG. 7 to uninstall the Trap Lock 100 the user depresses said trigger 306 to release the loose jaw latch 307 from said loose jaw 601. FIG. 7A. Said loose jaw 601 can then be disengaged from said loose jaw supports 500. FIG. 7B. Said loose jaw 601 is then slightly rotated upward to allow clearance of said loose jaw supports 500 for uninstallation. FIG. 7C. The user can then uninstall the Trap Lock 100 by simply pulling on said handle 205 to disengage said wedge 402 from said pan 603 bottom side 602. FIG. 7D. The trap 600 is now preloaded and ready to be set in the field.

It is understood that the foregoing examples are merely illustrative of the present invention. Certain modifications of the articles and/or methods may be made and still achieve the objectives of the invention. Such modifications are contemplated as within the scope of the claimed invention.

What is claimed is:

1. A Trap Lock comprising:
a main body, comprising an upper surface, a bottom surface, a first insertion end, and a second handle end;
a sear trigger assembly;
a sliding pan wedge assembly; and
a or a plurality of loose jaw supports; wherein
said Trap Lock is inserted into a loaded trap to prevent the loaded trap from firing.

2. The Trap Lock of claim 1, wherein said second handle end is comprised of a handle.

3. The Trap Lock of claim 1, wherein said sear trigger assembly is affixed to a central junction of said handle and said main body.

4. The Trap Lock of claim 3, wherein said sear trigger assembly is further comprised of a sear body fixed to a recess of said main body bottom surface.

5. The Trap Lock of claim 4, wherein said sear trigger assembly is further comprised of a sear trigger-latch connected to said sear body at two opposing sear body brackets.

6. The Trap Lock of claim 5, wherein said sear trigger-latch is connected with pins to said sear body to allow rotation of said sear trigger-latch.

7. The Trap Lock of claim 6, wherein said sear trigger assembly is further comprised of a sear spring between said sear body and said sear trigger-latch.

8. The Trap Lock of claim 7, wherein said sear spring provides tension to hold a loose jaw latch in an engaged position with a loose jaw of said loaded trap.

9. The Trap Lock of claim 8, wherein a trigger is connected to said sear trigger-latch and depressing said trigger disengages said loose jaw latch from said loose jaw.

10. The Trap Lock of claim 1, wherein said sliding pan wedge assembly is comprised of a substantially wedge shaped pan wedge and pan stop, which firmly locks a pan of said loaded trap in place to prevent any movement of said pan.

11. The Trap Lock of claim 10 wherein said sliding pan wedge assembly is further comprised of a flat bottom surface wherein a plurality of holes receive a plurality of screws, which engage a central channel of said main body to create a sliding connection between said pan wedge assembly and said main body.

12. The Trap Lock of claim 11 wherein said sliding pan wedge assembly is further comprised of a wedge spring assembly, which allows said pan wedge to slide toward said handle end and provide firm tension of said pan stop against said pan of a loaded trap.

13. The Trap Lock of claim 1, wherein said sliding pan wedge assembly prevents disengagement of a pan tab from a loaded jaw notch of a loaded jaw of said load trap.

14. The Trap Lock of claim 1, wherein said a or a plurality of loose jaw supports are affixed to said upper surface of said main body.

15. The Trap Lock of claim 1, wherein said a or a plurality of loose jaw supports are comprised of a lower main block and an upper loose jaw tab.

16. The Trap Lock of claim 15, wherein said loose jaw tab extends from said lower main block toward said second handle end.

17. The Trap Lock of claim 1, wherein said a or a plurality of loose jaw supports retain a loose jaw of said loaded trap in a fully open position.

18. A method of installing the Trap Lock of claim 1 comprising the steps of:
A. inserting said first insertion end underneath a loose jaw and a pan of said loaded trap to engage said sliding pan wedge assembly with a bottom side of said pan;
B. depressing a trigger of said sear-trigger assembly to move a loose jaw latch flush with said upper surface to allow said loose jaw to firmly engage with said a or a plurality of loose jaw supports;
C. releasing said trigger, which allows said loose jaw latch to firmly engage with said loose jaw.

19. The method of installing the Trap Lock of claim 18; wherein step B further comprises; wherein spring tension of said sliding pan wedge assembly provides firm tension of a pan stop against a first end of said pan and said sliding pan wedge assembly also provides a counter force toward said handle end, which firmly pushes said a or a plurality of loose jaw supports into said loose jaw wherein a loose jaw tab provides an upper stop to firmly grasp said loose jaw.

20. The method of installing the Trap Lock of claim 18; wherein step C further comprises: said sliding pan wedge assembly firmly engages the bottom side of said pan to prevent said pan from being depressed and prematurely firing said loaded trap.

21. The method of installing the Trap Lock of claim 18, further comprising the following step;
D. A user carrying said loaded trap by said second handle end to transport the loaded trap without risk of the loaded trap firing prematurely.
